(19) United States
(12) Patent Application Publication
(10) Pub. No.: US 2026/0362186 A1
(43) Pub. Date: Nov. 12, 2026

(54) METHOD AND APPARATUS FOR MEASURING CELL QUALITY BASED ON ARTIFICIAL INTELLIGENCE AND/OR MACHINE LEARNING

(71) Applicant: KT CORPORATION, Gyeonggi-do (KR)

(72) Inventor: Eun-Jong LEE, Gyeongi-do (KR)

(73) Assignee: KT CORPORATION, Gyeonggi-do (KR)

(21) Appl. No.: 19/713,567

(22) Filed: Jun. 18, 2026

Related U.S. Application Data
(63) Continuation of application No. PCT/KR2024/019813, filed on Dec. 5, 2024.

(30) Foreign Application Priority Data
Dec. 19, 2023 (KR) 10-2023-0186413
Dec. 3, 2024 (KR) 10-2024-0177187

(51) Int. Cl. H04W 24/08; H04W 24/10

(52) U.S. Cl. CPC H04W 24/08; H04W 24/10

(57) ABSTRACT

The provided are a method and an apparatus for measuring cell quality based on AI (artificial intelligence)/ML (machine learning). A UE receives, from a base station, information of a first cell list and information of a second cell list associated with the first cell list and measures a quality of at least one first cell belonging to the first cell list. The UE further predicts quality information of at least one second cell belonging to the second cell list, wherein the quality information of the at least one second cell is predicted using an AI (artificial intelligence)/ML (machine learning) model based on the measured quality of the at least one first cell.

### TECHNICAL FIELD

The present disclosure relates to wireless communications applicable to 5G NR, 5G-Advanced, and 6G.

### BACKGROUND OF THE INVENTION

As more communication devices demand greater communication traffic over time, a next-generation 5G system providing enhanced wireless broadband communication beyond the existing LTE system has been required. In the next-generation 5G system, referred to as New RAT, communication scenarios are classified into Enhanced Mobile BroadBand (eMBB)/Ultra-Reliability and Low-Latency Communication (URLLC)/Massive Machine-Type Communications (mMTC).

In the present disclosure, eMBB is a next-generation mobile communication scenario having characteristics such as High Spectrum Efficiency, High User Experienced Data Rate, and High Peak Data Rate; URLLC is a next-generation mobile communication scenario having characteristics such as Ultra Reliable, Ultra Low Latency, and Ultra High Availability (e.g., V2X, Emergency Service, Remote Control); and mMTC is a next-generation mobile communication scenario having characteristics such as Low Cost, Low Energy, Short Packet, and Massive Connectivity (e.g., IoT).

### SUMMARY OF THE INVENTION

The present disclosure may provide a method and an apparatus for enabling a UE (user equipment) to perform cell measurement, in particular neighboring cell measurement, using an AI/ML model for mobility management in a wireless communication system, and to report the measured cell quality results.

According to an embodiment, a method of UE may be provided for performing neighboring cell measurement in a wireless communication system. The method of UE may include receiving, from a base station, information of a first cell list and information of a second cell list associated with the first cell list, measuring a quality of at least one first cell belonging to the first cell list, and predicting quality information of at least one second cell belonging to the second cell list, wherein the quality information of the at least one second cell is predicted using an AI (artificial intelligence)/ML (machine learning) model based on the measured quality of the at least one first cell.

According to another embodiment, a method of a base station may be provided for performing neighboring cell measurement in a wireless communication system. The method of a base station may include transmitting, to a UE, information of a first cell list and information of a second cell list associated with the first cell list and receiving, from the UE, a measurement report based on quality information of at least one second cell belonging to the second cell list, wherein the quality information of the at least one second cell is predicted using an AI (artificial intelligence)/ML (machine learning) model based on the measured quality of at least one first cell belonging to the first cell list.

According to further another embodiment, a UE may be provided for performing neighboring cell measurement in a wireless communication system. The UE may include at least one processor; and at least one memory storing instructions and operably and electrically connectable to the at least one processor, wherein operations performed based on the instructions being executed by the at least one processor include: receiving, from a base station, information of a first cell list and information of a second cell list associated with the first cell list; and measuring a quality of at least one first cell belonging to the first cell list, and predicting quality information of at least one second cell belonging to the second cell list, wherein the quality information of the at least one second cell is predicted using an AI (artificial intelligence)/ML (machine learning) model based on the measured quality of the at least one first cell.

According to still another embodiment, a base station may be provided for performing neighboring cell measurement in a wireless communication system. The base station may include at least one processor; and at least one memory storing instructions and operably and electrically connectable to the at least one processor, wherein operations performed based on the instructions being executed by the at least one processor include: transmitting, to a UE, information of a first cell list and information of a second cell list associated with the first cell list; and thereafter, receiving, from the UE, a measurement report based on quality information of at least one second cell belonging to the second cell list, wherein the quality information of the at least one second cell is predicted using an AI (artificial intelligence)/ML (machine learning) model based on a measured quality of at least one first cell belonging to the first cell list.

The UE may evaluate a measurement reporting condition based on the predicted quality information of the at least one second cell and may transmit a measurement report to the base station based on satisfaction of the evaluated measurement reporting condition.

Meanwhile, the first cell list may be associated with input of the AI/ML model, and the second cell list may be associated with output of the AI/ML model. Further, the second cell list may include the first cell list.

Additionally, the information of the first cell list and the information of the second list may be transmitted from the base station to the UE through an RRC (radio resource control) message including a measurement configuration, and the UE may receive the RRC message.

According to the embodiments of the present disclosure, when a UE performs cell measurement using an AI/ML model, in particular neighboring cell measurement, the UE may measure a smaller number of cells than in the typical technique, thereby alleviating the cell measurement burden of the UE.

### BRIEF DESCRIPTION OF THE DRAWINGS

FIG. 1 is a diagram illustrating a wireless communication system.

FIG. 2 illustrates a structure of a radio frame used in NR.

FIGS. 3A through 3C are diagrams illustrating architectures for a wireless communication service.

FIG. 4 illustrates a slot structure of an NR frame.

FIG. 5 illustrates a subframe type in NR.

FIG. 6 illustrates a structure of a self-contained slot.

FIG. 7 illustrates a handover procedure.

FIG. 8 illustrates a high-level measurement model in NR.

FIG. 9 is a flowchart illustrating a method of operating a UE according to an embodiment.

FIGS. 10A and 10B illustrate an example of cell measurement.

FIGS. 11A and 11B illustrate another example of cell measurement.

FIG. 12 illustrates a procedure of a UE and a base station according to an embodiment.

FIG. 13 is a flowchart illustrating a method of operating a UE according to an embodiment.

FIG. 14 is a flowchart illustrating a method of operating a base station according to an embodiment.

FIG. 15 illustrates an apparatus according to an embodiment.

FIG. 16 is a block diagram illustrating a configuration of a UE according to an embodiment.

FIG. 17 is a block diagram illustrating a configuration of a processor according to an embodiment.

FIG. 18 is a block diagram illustrating in detail the transceiver of the apparatus shown in FIG. 15 or the transceiver of the apparatus shown in FIG. 16.

### DETAILED DESCRIPTION OF THE INVENTION

It should be noted that the technical terms used herein are used merely to describe particular embodiments and are not intended to limit the contents of the present disclosure. Furthermore, unless specifically defined herein otherwise, the technical terms used herein should be construed as generally understood by those skilled in the relevant art of the present disclosure and should not be construed in an overly comprehensive or overly narrow meaning. Furthermore, when the technical terms used herein are technical terms not accurately representing the contents and spirit of the present disclosure, the technical terms may be replaced and understood as technical terms correctly understandable to those skilled in the art. Furthermore, the general terms used herein should be construed as defined in the dictionary or in accordance with the context, and should not be construed in an overly narrow meaning.

Also, the singular expressions used herein include plural expressions unless the context clearly dictates otherwise. In the present application, terms such as “comprises,” “includes,” or “has” should not be construed as necessarily including all of the various components or various steps described in the specification; rather, some of the components or some of the steps may not be included, or additional components or steps may be further included.

Furthermore, although the terms including ordinal numbers such as “first,” “second,” and the like used herein may be used to describe various components, the components should not be limited by the terms. The terms are used merely to distinguish one component from another. For example, a first component may be referred to as a second component, and similarly, a second component may also be referred to as a first component, without departing from the scope of the disclosure.

When a component is referred to as being “connected” or “linked” to another component, it may be directly connected or linked to the other component, but other components may also exist between the components. On the other hand, when a component is referred to as being “directly connected” or “directly linked” to another component, it should be understood that no other component exists between the components.

Hereinafter, embodiments will be described in detail with reference to the accompanying drawings, where the same or similar components are given the same reference numerals regardless of the reference numerals used in the drawings, and repeated descriptions thereof will be omitted. Furthermore, in describing the contents of the present disclosure, when it is considered that a specific description of related known technologies may obscure the gist of the present disclosure, the detailed description thereof will be omitted. It should also be noted that the accompanying drawings are merely intended to facilitate understanding of the contents and spirit of the present disclosure, and the contents and spirit of the present disclosure should not be construed as being limited by the accompanying drawings. The contents and spirit of the present disclosure should be construed as extending to all modifications, equivalents, and substitutes in addition to the embodiments illustrated in the accompanying drawings.

In the present disclosure, “A or B” may mean “only A,” “only B,” or “both A and B.” Stated otherwise, “A or B” in the present disclosure may be interpreted as “A and/or B.” For example, “A, B or C” in the present disclosure may mean “only A,” “only B,” “only C,” or “any combination of A, B and C.”

A slash (/) or a comma used in the present disclosure may mean “and/or.” For example, “A/B” may mean “A and/or B.” Accordingly, “A/B” may mean “only A,” “only B,” or “both A and B.” For example, “A, B, C” may mean “A, B or C.”

In the present disclosure, “at least one of A and B” may mean “only A,” “only B,” or “both A and B.” Furthermore, in the present disclosure, the expressions “at least one of A or B” or “at least one of A and/or B” may be interpreted in the same manner as “at least one of A and B.”

Also, in the present disclosure, “at least one of A, B and C” may mean “only A,” “only B,” “only C,” or “any combination of A, B and C.” In addition, “at least one of A, B or C” or “at least one of A, B and/or C” may mean “at least one of A, B and C.”

Furthermore, parentheses used in the present disclosure may mean “for example.” Specifically, when an expression is given as “control information (PDCCH),” it may indicate that “PDCCH (Physical Downlink Control Channel)” is proposed as an example of “control information.” Stated otherwise, “control information” in the present disclosure is not limited to “PDCCH”; rather, “PDDCH” may be proposed as an example of “control information.” In addition, even when an expression is given as “control information (i.e., PDCCH),” it may indicate that “PDCCH” is proposed as an example of “control information.”

Technical features described individually within one drawing in the present disclosure may be implemented individually or simultaneously.

In the accompanying drawings, a UE (User Equipment) is illustrated; however, the illustrated UE may also be referred to using terms such as Terminal, ME (Mobile Equipment), or the like. Furthermore, the UE may be a portable device such as a notebook computer, a mobile phone, a PDA, a smartphone, or a multimedia device, or may be a non-portable device such as a PC or a vehicle-mounted device.

Hereinafter, a UE is used as an example of a device capable of wireless communication (e.g., a wireless communication device, a wireless device, or a wireless apparatus). Operations performed by the UE may be performed by any device capable of wireless communication. A device capable of wireless communication may also be referred to as a wireless communication device, a wireless device, a wireless apparatus, or the like.

The term “base station” used hereinafter generally refers to a fixed station communicating with wireless devices, and may be used as a generic term encompassing an eNodeB (evolved-NodeB), an eNB (evolved-NodeB), a BTS (Base Transceiver System), an Access Point, a gNB (Next generation NodeB), an RRH (remote radio head), a TP (transmission point), an RP (reception point), a relay, and the like.

While the present disclosure describes embodiments using an LTE system, an LTE-A system, and an NR system, such embodiments may be applied to any communication system falling within the above definition.

### Wireless Communication System

Driven by the success of LTE (long term evolution)/LTE-Advanced (LTE-A) for fourth-generation mobile communication, commercialization and follow-up research on the fifth-generation (5G) mobile communication are continuously underway.

The fifth-generation mobile communication defined by the International Telecommunication Union (ITU) refers to a system providing a data transmission rate of up to 20 Gbps and a perceived transmission rate of at least 100 Mbps anywhere. The formal name thereof is referred to as “IMT-2020.”

The ITU has proposed three main usage scenarios, such as eMBB (enhanced Mobile BroadBand), mMTC (massive Machine Type Communication), and URLLC (Ultra Reliable and Low Latency Communications).

URLLC relates to usage scenarios requiring high reliability and low latency. For example, services such as autonomous driving, factory automation, and augmented reality require high reliability and low latency (e.g., latency of 1 ms or less). The current latency of 4G (LTE) is statistically 21-43 ms (best 10%) and 33-75 ms (median). This is insufficient to support services requiring latency of 1 ms or less. Next, the eMBB usage scenario relates to usage scenarios requiring mobile ultra-wideband (e.g., ultra-broadband).

That is, the fifth-generation mobile communication system supports higher capacity than the current 4G LTE, increases the density of mobile broadband users, and can support D2D (Device to Device), high reliability, and MTC (Machine Type Communication). Research and development for 5G also targets lower latency and lower battery consumption than the 4G mobile communication system in order to better implement the Internet of Things. For such 5G mobile communication, a new radio access technology (New RAT or NR) may be proposed.

An NR frequency band may be defined as two types of frequency ranges (FR1, FR2). The numerical values of the frequency ranges may be changed; for example, the frequency ranges of the two types (FR1, FR2) may be as shown in Table 1 below. For convenience of description, among the frequency ranges used in the NR system, FR1 may refer to a “sub 6 GHz range,” and FR2 may refer to an “above 6 GHz range” and may be referred to as millimeter wave (mmW).

TABLE 1

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

The numerical values of the frequency ranges of the NR system may be changed. For example, FR1 may include a band of 410 MHz to 7125 MHz as shown in Table 1. That is, FR1 may include frequency bands at or above 6 GHz (or 5850, 5900, 5925 MHz, etc.). For example, the frequency band of 6 GHZ (or 5850, 5900, 5925 MHz, etc.) or higher included within FR1 may include an unlicensed band. The unlicensed band may be used for various purposes, for example, for vehicle communications (e.g., autonomous driving).

Meanwhile, the 3GPP-based communication standards define downlink physical channels corresponding to resource elements carrying information originating from a higher layer, and downlink physical signals corresponding to resource elements used by the physical layer but not carrying information originating from a higher layer. For example, a physical downlink shared channel (PDSCH), a physical broadcast channel (PBCH), a physical multicast channel (PMCH), a physical control format indicator channel (PCFICH), a physical downlink control channel (PDCCH), and a physical hybrid ARQ indicator channel (PHICH) are defined as downlink physical channels, and reference signals and synchronization signals are defined as downlink physical signals. A reference signal (RS), also referred to as a pilot, refers to a predefined signal of a specific waveform known to the gNB and the UE; for example, a cell-specific RS, a UE-specific RS (UE-RS), a positioning RS (PRS), and a channel state information RS (CSI-RS) are defined as downlink reference signals. The 3GPP LTE/LTE-A standards define uplink physical channels corresponding to resource elements carrying information originating from a higher layer, and uplink physical signals corresponding to resource elements used by the physical layer but not carrying information originating from a higher layer. For example, a physical uplink shared channel (PUSCH), a physical uplink control channel (PUCCH), and a physical random access channel (PRACH) are defined as uplink physical channels, and a demodulation reference signal (DMRS) for uplink control/data signals and a sounding reference signal (SRS) used for uplink channel measurement are defined.

In the present disclosure, PDCCH (Physical Downlink Control CHannel)/PCFICH (Physical Control Format Indicator CHannel)/PHICH (Physical Hybrid automatic retransmit request Indicator CHannel)/PDSCH (Physical Downlink Shared CHannel) respectively refer to a set of time-frequency resources or a set of resource elements carrying DCI (Downlink Control Information)/CFI (Control Format Indicator)/downlink ACK/NACK (ACKnowledgement/Negative ACK)/downlink data. Furthermore, PUCCH (Physical Uplink Control CHannel)/PUSCH (Physical Uplink Shared CHannel)/PRACH (Physical Random Access CHannel) respectively refer to a set of time-frequency resources or a set of resource elements carrying UCI (Uplink Control Information)/uplink data/random access signals.

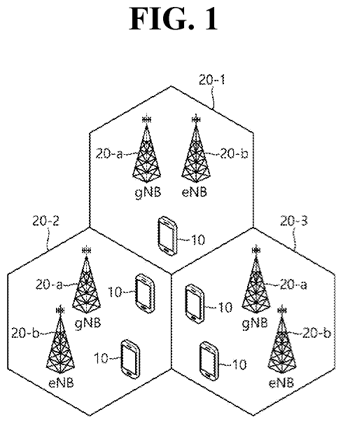

FIG. 1 is a diagram illustrating a wireless communication system.

Referring to FIG. 1, a wireless communication system includes at least one base station (BS). The BS is classified into a gNodeB (or gNB) 20a and an eNodeB (or eNB) 20b. The gNB 20a supports fifth-generation mobile communication. The eNB 20b supports fourth-generation mobile communication, i.e., LTE (long term evolution).

Each of the base stations 20a and 20b provides communication services to a specific geographic area (generally referred to as a cell) 20-1, 20-2, 20-3. A cell may further be divided into a plurality of areas (referred to as sectors).

A UE (user equipment) typically belongs to one cell, referred to as the serving cell. The base station providing communication services to the serving cell is referred to as the serving BS. Since a wireless communication system is a cellular system, other cells adjacent to the serving cell exist. The other cells adjacent to the serving cell are referred to as neighbor cells. A base station providing communication services for a neighbor cell is referred to as a neighbor BS. The serving cell and the neighbor cells are determined relatively relative to the UE.

Hereinafter, downlink refers to communication from the base station 20 to the UE 10, and uplink refers to communication from the UE 10 to the base station 20. In the downlink, the transmitter may be part of the base station 20, and the receiver may be part of the UE 10. In the uplink, the transmitter may be a part of the UE 10, and the receiver may be part of the base station 20.

Meanwhile, wireless communication systems may be largely classified into FDD (frequency division duplex) schemes and TDD (time division duplex) schemes. According to the FDD scheme, uplink transmission and downlink transmission are performed using different frequency bands. According to the TDD scheme, uplink transmission and downlink transmission are performed using the same frequency band but at different times. The channel response of the TDD scheme is substantially reciprocal. That is, the downlink channel response and the uplink channel response are nearly identical in a given frequency domain. Accordingly, a TDD-based wireless communication system has the advantage of obtaining the downlink channel response from the uplink channel response. In the TDD scheme, since the entire frequency band is time-divided between uplink transmission and downlink transmission, downlink transmission by the base station and uplink transmission by the UE cannot be performed simultaneously. In a TDD system that distinguishes uplink transmission and downlink transmission on a subframe basis, uplink transmission and downlink transmission are performed in different subframes.

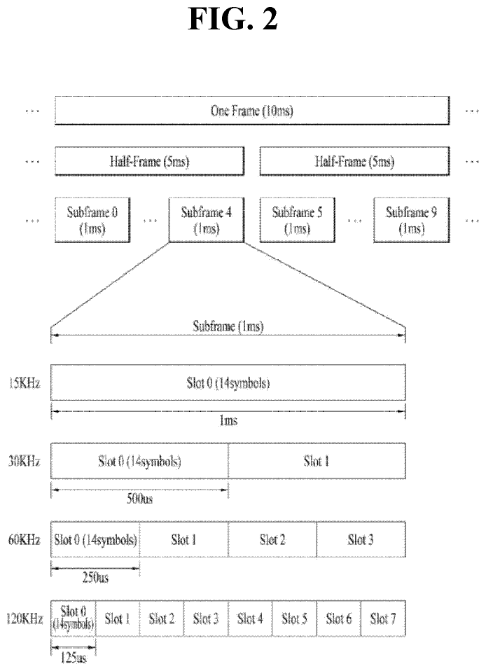

FIG. 2 illustrates a structure of a radio frame used in NR.

In NR, uplink and downlink transmissions are organized into frames. A radio frame has a length of 10 ms and is defined by two 5 ms half-frames (HFs). A half-frame is defined by five 1 ms subframes (SFs). A subframe is divided into one or more slots, and the number of slots in a subframe depends on the SCS (Subcarrier Spacing). Each slot includes 12 or 14 OFDM (A) symbols depending on the CP (cyclic prefix). When the normal CP is used, each slot includes 14 symbols. When the extended CP is used, each slot includes 12 symbols. Here, the symbol may include an OFDM symbol (or a CP-OFDM symbol) and an SC-FDMA symbol (or a DFT-s-OFDM symbol).

### Support of Various Numerologies

In an NR system, in line with the development of wireless communication technologies, multiple numerologies may be provided to a UE. For example, when SCS is 15 kHz, a wide area in traditional cellular bands is supported; when SCS is 30 kHz/60 kHz, dense-urban areas, lower latency, and wider carrier bandwidth are supported; and when SCS is 60 kHz or higher, bandwidths greater than 24.25 GHz are supported to overcome phase noise.

The numerology may be defined by the length of a CP (cycle prefix) and a Subcarrier Spacing (SCS). One cell may provide a plurality of numerologies to a UE. When the numerology index is denoted by μ, each subcarrier spacing and the corresponding CP length may be as shown in the table 2 below.

TABLE 2

| μ | Δf = 2^{μ}15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For the normal CP case, when the numerology index is denoted by u, the number of OFDM symbols per slot (N^{slot}_{symb}), the number of slots per frame (N^{frame,μ}ₛₗₒₜ), and the number of slots per subframe (N^{subframe,μ}ₛₗₒₜ) are as shown in the table below.

TABLE 3

| μ | Δf = 2^{μ}15 [kHz] | N^{slot}_{symb} | N^{frame, μ}ₛₗₒₜ | N^{subframe, μ}ₛₗₒₜ |
|---|---|---|---|---|
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

For the extended CP case, when the numerology index is denoted by u, the number of OFDM symbols per slot (N^{slot}_{symb}), the number of slots per frame (N^{frame,μ}ₛₗₒₜ), and the number of slots per subframe (Nsub^{frame,μ}ₛₗₒₜ) are as shown in the table below.

TABLE 4

| μ | SCS (15*2^{u}) | N^{slot}_{symb} | N^{frame, μ}ₛₗₒₜ | N^{subframe, μ}ₛₗₒₜ |
|---|---|---|---|---|
| 2 | 60 KHz (u = 2) | 12 | 40 | 4 |

In an NR system, the OFDM (A) numerology (e.g., SCS, CP length, etc.) may be configured differently among a plurality of cells aggregated to a single UE. Accordingly, the (absolute time) duration of a time resource (e.g., SF, slot, or TTI) (for convenience, collectively referred to as a TU (Time Unit)) consisting of the same number of symbols may be configured differently among the aggregated cells.

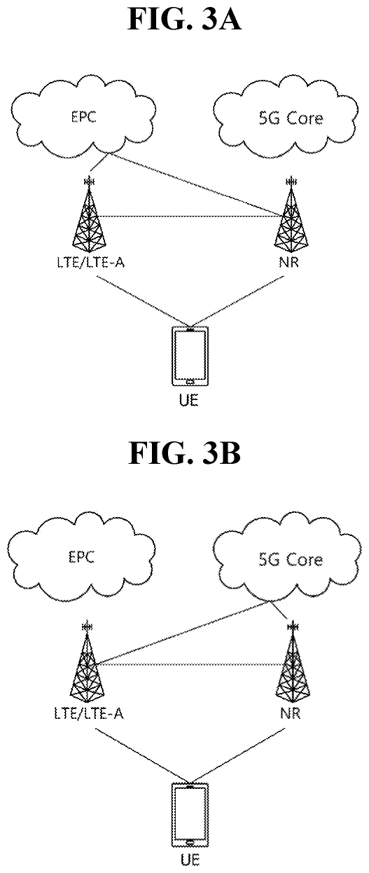

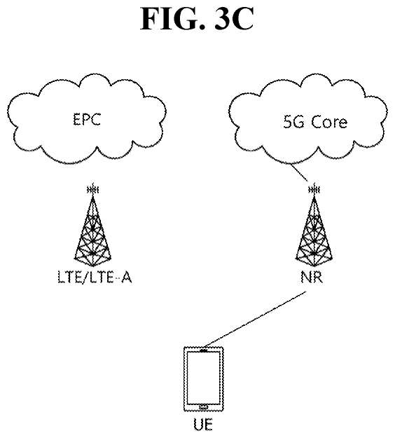

FIG. 3A through FIG. 3C are diagrams illustrating exemplary architectures for a wireless communication service.

Referring to FIG. 3A, a UE is connected to an LTE/LTE-A-based cell and an NR-based cell in a DC (dual connectivity) manner.

The NR-based cell is connected to the core network for the existing fourth-generation mobile communication, i.e., the EPC (Evolved Packet Core).

Referring to FIG. 3B, unlike FIG. 3A, the LTE/LTE-A-based cell is connected to the core network for fifth-generation mobile communication, i.e., the 5G core network.

The service scheme based on the architectures shown in FIG. 3A and FIG. B is referred to as NSA (non-standalone).

Referring to FIG. 3C, the UE is connected only to the NR-based cell. The service scheme based on such an architecture is referred to as SA (standalone).

Meanwhile, in the NR, it may be considered that reception from the base station uses downlink subframes, and transmission to the base station uses uplink subframes. This scheme may be applied to paired spectrum and unpaired spectrum. A pair of spectrums means that two carrier spectrums are included for downlink and uplink operations. For example, in a pair of spectrums, one carrier may include a downlink band and an uplink band paired with each other.

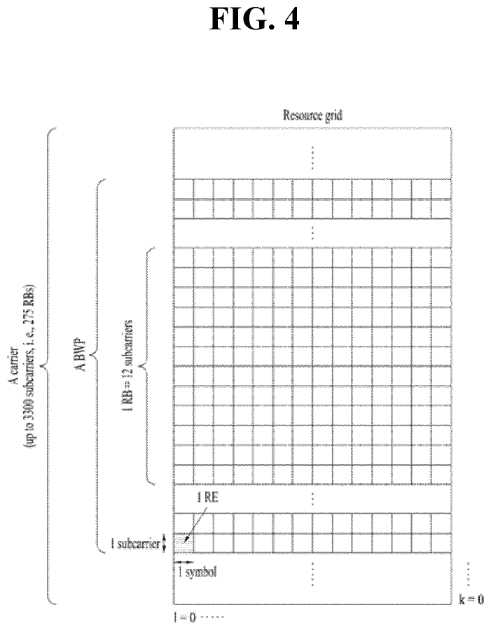

FIG. 4 illustrates a slot structure of an NR frame.

A slot includes a plurality of symbols in the time domain. For example, in the case of the normal CP, one slot includes 14 symbols; in the case of the extended CP, one slot includes 12 symbols. A carrier includes a plurality of subcarriers in the frequency domain. An RB (Resource Block) is defined as a plurality (e.g., 12) of consecutive subcarriers in the frequency domain. A BWP (Bandwidth Part) is defined as a plurality of consecutive (physical, P) RBs in the frequency domain, and may correspond to one numerology (e.g., SCS, CP length, etc.). A UE may be configured with up to N (e.g., 4) BWPs in each of the downlink and the uplink. Downlink or uplink transmission is performed via an activated BWP, and at a given time, only one BWP among the BWPs configured for the UE may be activated. Each element in a resource grid is referred to as a Resource Element (RE), and one complex symbol may be mapped to the resource element.

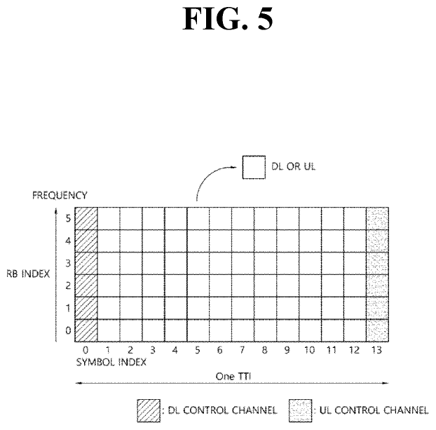

FIG. 5 illustrates an example of a subframe type in NR.

The TTI (transmission time interval) illustrated in FIG. 5 may be referred to as a subframe or slot for NR (or New RAT). The subframe (or slot) of FIG. 5 may be used in the TDD system of NR (or New RAT) to minimize data transmission latency. As illustrated in FIG. 5, the subframe (or slot) includes 14 symbols. The leading symbols of the subframe (or slot) may be used for a downlink (DL) control channel, and the trailing symbols of the subframe (or slot) may be used for an uplink (UL) control channel. The remaining symbols may be used for DL data transmission or UL data transmission. According to this subframe (or slot) structure, downlink transmission and uplink transmission may proceed sequentially within one subframe (or slot). Accordingly, downlink data may be received within the subframe (or slot), and an uplink acknowledgement (ACK/NACK) may be transmitted within the subframe (or slot).

Such a subframe (or slot) structure may be referred to as a self-contained subframe (or slot).

Specifically, the first N symbols within the slot are used to transmit the DL control channel (hereinafter, DL control region), and the last M symbols within the slot may be used to transmit the UL control channel (hereinafter, UL control region). N and M are each integers greater than or equal to 0. The resource region between the DL control region and the UL control region (hereinafter, data region) may be used for DL data transmission or UL data transmission. For example, in the DL control region, a physical downlink control channel (PDCCH) may be transmitted, and in the DL data region, a physical downlink shared channel (PDSCH) may be transmitted. In the UL control region, a physical uplink control channel (PUCCH) may be transmitted, and in the UL data region, a physical uplink shared channel (PUSCH) may be transmitted.

Using such a subframe (or slot) structure reduces the time required to retransmit erroneously received data, thereby minimizing the final data transmission latency. In such a self-contained subframe (or slot) structure, a time gap may be required in the process of transitioning from transmission mode to reception mode or from reception mode to transmission mode. To this end, in the subframe structure, some OFDM symbols at the transition from DL to UL may be configured as a Guard Period (GP).

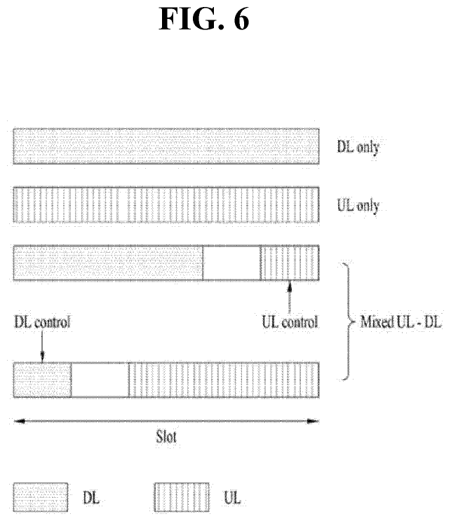

FIG. 6 illustrates a structure of a self-contained slot.

In an NR system, a frame is characterized by a self-contained structure capable of including a DL control channel, DL or UL data, a UL control channel, and the like all within a single slot. For example, the first N symbols within the slot are used to transmit the DL control channel (hereinafter, DL control region), and the last M symbols within the slot may be used to transmit the UL control channel (hereinafter, UL control region). N and M are each integers greater than or equal to 0. The resource region between the DL control region and the UL control region (hereinafter, data region) may be used for DL data transmission or UL data transmission. For example, the following configurations may be considered. Each interval is listed in chronological order.
1. DL only configuration
2. UL only configuration
3. Mixed UL-DL configuration
   DL region+GP (Guard Period)+UL control region
   DL control region+GP+UL region
DL region: (i) DL data region, (ii) DL control region+DL data region
UL region: (i) UL data region, (ii) UL data region+UL control region

In the DL control region, the PDCCH may be transmitted, and in the DL data region, the PDSCH may be transmitted. In the UL control region, the PUCCH may be transmitted, and in the UL data region, the PUSCH may be transmitted. In the PDCCH, DCI (Downlink Control Information), for example, DL data scheduling information, UL data scheduling information, and the like, may be transmitted. In the PUCCH, UCI (Uplink Control Information), for example, ACK/NACK (Positive Acknowledgement/Negative Acknowledgement) information for the DL data, CSI (Channel State Information) information, SR (Scheduling Request), and the like, may be transmitted. The GP provides a time gap during the transition of the base station and the UE from transmission mode to reception mode or from reception mode to transmission mode. Within a subframe, some symbols at the transition from DL to UL may be configured as a GP.

Hereinafter, mobility in RRC_CONNECTED will be described. Reference may be made to clause 9.2.3 of 3GPP TS 38.300 v17.6.0.

Network controlled mobility applies to UEs in RRC_CONNECTED and may be classified into two types: cell level mobility and beam level mobility, where cell level mobility is triggered through explicit RRC signaling.

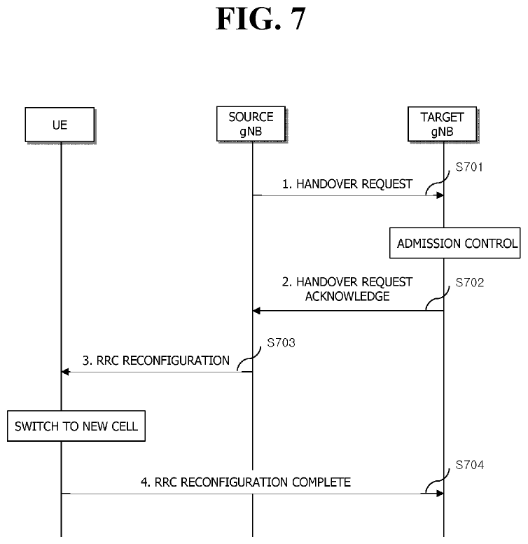

FIG. 7 illustrates a handover procedure.

Referring to FIG. 7, the source base station (source gNB) initiates the handover and transmits a handover request message to the target base station (target gNB) via the Xn interface (S701). The target base station performs admission control and provides a new RRC configuration to the source base station as part of a handover request acknowledge message (S702). The source base station provides the RRC configuration to the UE by forwarding the RRC reconfiguration message received in the handover request acknowledge message (S703). The RRC reconfiguration message includes at least the cell ID and all information necessary to access the target cell, so that the UE can access the target cell without reading the system information. In some cases, information necessary for contention-based and contention-free random access may be included in the RRC reconfiguration message. The access information for the target cell may include beam-specific information, if any. Thereafter, the UE switches to the new cell (or target cell), i.e., moves the RRC connection to the target base station, and transmits an RRC reconfiguration complete message (S704).

Hereinafter, measurement in RRC_CONNECTED will be described. Reference may be made to clause 9.2.4 of 3GPP TS 38.300 v17.6.0.

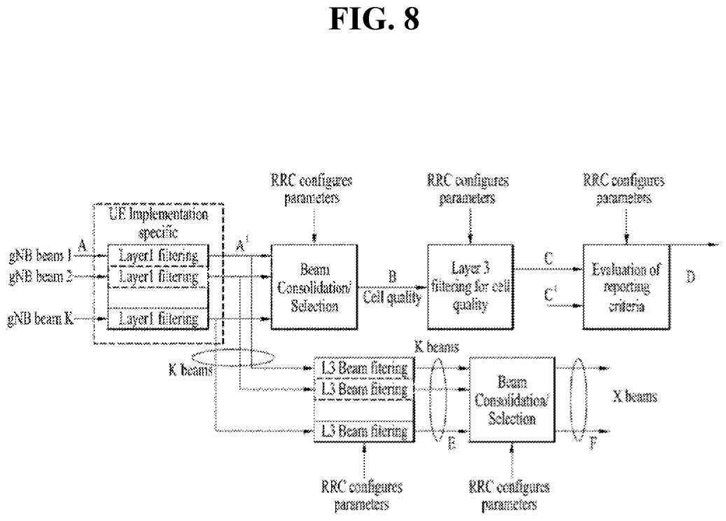

FIG. 8 illustrates an example of a high-level measurement model in NR.

In RRC_CONNECTED, the UE measures a plurality of beams (at least one) of a cell, and the measurement results (power values) are averaged to derive the cell quality. As such, the UE may consider a subset of the detected beams, i.e., the N best beams above an absolute threshold. Filtering is performed at two different levels: at the physical layer to derive the beam quality, and then at the RRC level to derive the cell quality from multiple beams. The cell quality derived from the beam measurements is obtained in the same manner for the serving cell(s) and the non-serving cell(s). The measurement report may include the measurement results of the X best beams, if configured by the base station (gNB).

Referring to FIG. 8, a more detailed description is given below.

The K beams correspond to measurements on SSB or CSI-RS resources configured by the base station for L3 mobility and detected by the UE at L1.

‘A’ represents measurements (beam-specific samples) internal to the physical layer.

‘Layer 1 filtering’ refers to internal Layer 1 filtering of the inputs measured at point A. The exact filtering is implementation-dependent. How and exactly when the measurements are performed at the physical layer through implementation (input A and Layer 1 filtering) is not constrained by the standard.

‘A¹’ represents measurements reported by Layer 1 to Layer 3 after Layer 1 filtering (i.e., beam-specific measurements).

‘Beam Consolidation/Selection’ refers to an operation of consolidating beam-specific measurements to derive the cell quality when N>1, and selecting the best beam measurement to derive the cell quality when N=1. The operation of beam consolidation/selection is standardized, and the configuration of this module is provided by RRC signaling. The reporting period at B is equal to one measurement period at A¹.

‘B’ represents a measurement (i.e., cell quality) derived from the beam-specific measurements reported to Layer 3 after beam consolidation/selection.

‘Layer 3 filtering for cell quality’ is filtering performed on the measurement provided at point B. The operation of the Layer 3 filters is standardized, and the configuration of the Layer 3 filters is provided by RRC signaling. The filtering reporting period at C is equal to one measurement period at B.

‘C’ represents a measurement after processing in the Layer 3 filter. The reporting rate is the same as the reporting rate at point B. This measurement is used as input for one or more reporting criteria evaluations.

‘Evaluation of reporting criteria’ refers to determining whether an actual measurement report is required at point D. The evaluation may be performed based on, for example, one or more flows of measurements at reference point C to compare different measurements. This is represented as inputs C and C¹. The UE shall evaluate the reporting criteria at least every time a new measurement result is reported at points C and C¹. The reporting criteria are standardized, and the configuration of the reporting criteria is provided by RRC signaling (UE measurements).

‘D’ represents measurement report information (message) transmitted over the radio interface.

‘L3 Beam filtering’ is filtering performed on the measurements (i.e., beam-specific measurements) provided at point A¹. The operation of the beam filters is standardized, and the configuration of the beam filters is provided by RRC signaling. The filtering reporting period at point E is equal to one measurement period at point A1.

‘E’ represents measurements after processing in the beam filter (i.e., beam-specific measurements). The reporting rate is the same as the reporting rate at point A1. These measurements are used as input for selecting the X measurements to be reported.

‘Beam Selection for beam reporting’ selects X measurements from the measurements provided at point E. The operation of the beam selection is standardized, and the configuration of the beam selection module is provided by RRC signaling.

‘F’ represents beam measurement information included in the measurement report (transmitted) over the radio interface.

Layer 1 filtering introduces a certain level of measurement averaging. How and when the UE accurately performs the required measurements is implementation-specific to the point that the output at B fulfills the performance requirements set forth in 3GPP TS 38.133.

Layer 3 filtering for cell quality and the relevant parameters used are specified in 3GPP TS 38.331, and do not introduce delay in the sample availability between B and C. The measurements at points C and C¹ are inputs used for event evaluation. L3 beam filtering and the relevant parameters used are specified in 3GPP TS 38.331, and do not introduce delay in the sample availability between E and F.

The measurement reports have the following characteristics:
1) The measurement reports include the measurement identity of the relevant measurement configuration triggering the report;
2) The cell and beam measurement quantities to be included in the measurement reports are configured by the network;
3) The number of non-serving cells to be reported may be limited through network configuration;
4) Cells belonging to an exclude-list configured by the network are not used for event evaluation and reporting; conversely, when an allow-list is configured by the network, only cells belonging to the allow-list are used for event evaluation and reporting;
5) The beam measurements to be included in the measurement reports are configured by the network (beam identifier only, measurement result and beam identifier, or no beam reporting).

In 3GPP Release-18, studies have been carried out on technologies for applying AI/ML models to use cases such as beam management (BM), positioning, and CSI feedback. As a result of these studies, it has been determined in Release-19 to formally proceed with AI/ML specification work for improving the accuracy of beam management and positioning. Based on the results of such studies, attempts to apply AI/ML to communication technologies have been made in various fields, and in Release-19, new studies on AI/ML based mobility are expected to begin under the leadership of RAN2.

In the case of BM, as discussed in RAN1, studies on ‘AI/ML for BM’ have been conducted to reduce not only the burden/latency of beam measurement for mobility between beams configured within one cell, but also the overhead for reference signal resources allocated for beam measurement. NR experiences frequent link failures due to beamforming techniques in high-frequency bands. This also affects inter-cell handover (HO) decision-making, and since beam link failures may cause frequent handovers or handover failures, to address such problems, NR mobility enhancement has been continuously discussed, and the following features have been defined.
CHO (Conditional HO) in Rel-16;
ICBM (Inter-Cell Beam Management) in Rel-17;
LTM (Lower-layer Triggered Mobility) in Rel-18.

That is, not only HO but also BM may be considered one of the key elements for mobility. Similar to ‘AI/ML for BM’ studied in Release-18, by applying an AI/ML model to facilitate seamless mobility of the UE between cells, various techniques may be proposed for measuring only a portion of neighboring cells, thereby reducing not only the measurement burden but also the HO latency. This may not only enable measuring some cells instead of measuring all neighboring cells, but may also enable predicting the signal strength/quality of cells through partial beam measurements of neighboring cells; or, by predicting the measurement reporting time and the HO execution time from the current neighboring cell measurements and preparing the HO in advance, the interruption time may be minimized and the HO accuracy may be improved.

As described above, 3GPP has thus far required continuously performing measurements not only on the serving cell but also on neighboring cells to maintain the link connectivity of a mobile UE. However, with the evolution of network architectures, cells of various sizes have emerged, leading to environments in which a large number of cells are deployed. As a result, the burden on the UE to measure a large number of cells has grown, leading to significant overhead and increased complexity for the UE. In 5G as well, various techniques have been proposed to reduce such measurement burden, and measurement relaxation and mobility enhancement have been studied as the major issues of 5G.

However, because typical measurement relaxation techniques are performed based on base station configuration, problems may arise where HO cannot be performed in a timely manner, eventually causing HO delays and link disconnections.

Recently, as AI/ML technologies have been applied to various communication fields, various approaches have been proposed to solve such overhead and complexity issues. When AI/ML models predicting the signal strength/quality of neighboring cells or the mobility timing are used, it is expected not only to reduce the cell measurement burden of the UE, but also to improve HO performance by enabling inter-cell mobility to be performed at the optimal timing.

In order to predict the signal strength/quality of neighboring cells based on an AI/ML model, a new signaling scheme needs to be defined between the base station and the UE. In particular, when, instead of measuring all neighboring cells, the signal strength/quality of all candidate cells is predicted through measurement of the signal strength/quality only on cells to be used as input to the model, a scheme is needed for the base station to indicate, to the UE, information on the candidate cells to be derived as output of the model and on the measurement cells to be used as the input to the model.

The present disclosure proposes a method of a UE for performing neighboring-cell measurement and reporting based on prediction of neighboring-cell signal strength/quality using an AI/ML model.

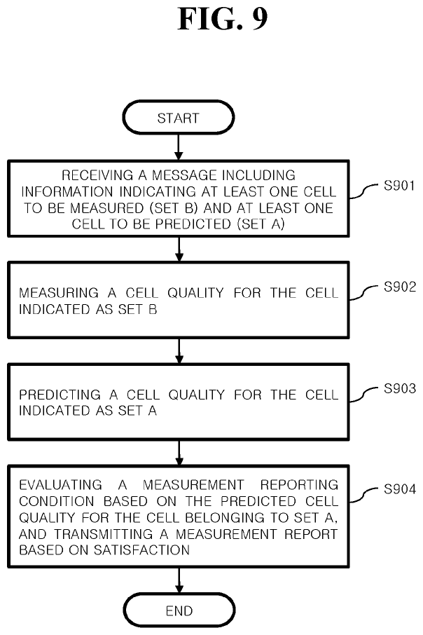

FIG. 9 is a flowchart illustrating a method of operating a UE according to an embodiment of the present disclosure.

Based on the AI/ML model information supported by the UE, the base station transmits a measurement configuration message to the UE, the measurement configuration message including indicators for indicating information on the cells to be used as the inputs to the AI/ML model (hereinafter referred to as Cell_SetB) and information on the cells to be derived as the outputs of the AI/ML model (hereinafter referred to as Cell_SetA). The UE, upon receiving the message, uses the signal strength measurements of the cells belonging to Cell_SetB as the input to the AI/ML model, and predicts the signal strengths of the cells belonging to Cell_SetA. If any of the predicted cells satisfy an event configured by the base station, the UE reports the predicted/measured signal strengths to the base station.

Referring to FIG. 9, the UE receives, from the base station, a message including information indicating at least one cell to be measured (Set B) and at least one cell to be predicted (Set A) (S901). Based on the received information, the UE measures the cell quality for the cells indicated as Set B (S902) and uses the measured cell quality as inputs to the AI/ML model to predict the cell quality for the cells indicated as Set A (S903). Thereafter, the UE evaluates the reporting conditions based on the predicted cell quality for the cells belonging to Set A, and, if satisfied, transmits a reporting message to the base station (S904).

It is assumed that the AI/ML model is a model predicting the signal strength/quality for all neighboring cells (Cell_SetA) using the measurement result values for some neighboring cells (Cell_SetB) as inputs. This may be a model predicting the current/future signal strength of neighboring cells based on the mobility characteristics of the UE (e.g., speed, direction, etc.).

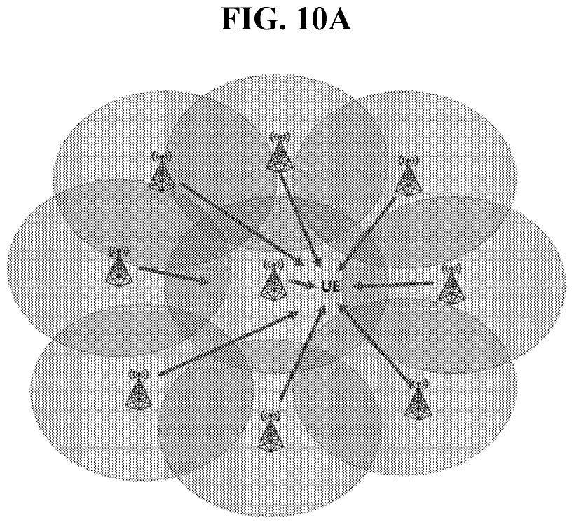

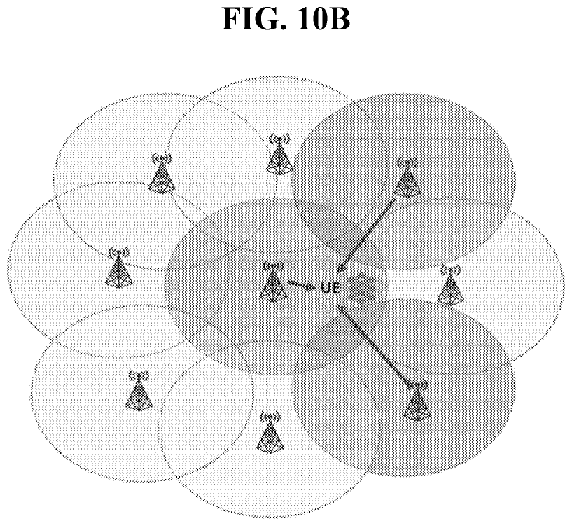

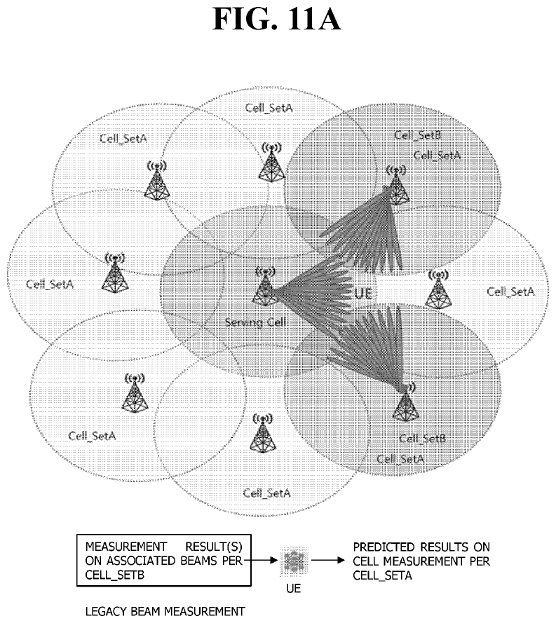

FIGS. 10A and 10B illustrate examples of cell measurement.

FIGS. 10A and 10B illustrate examples of neighboring cell measurement performed by a UE, and in particular, FIG. 10B illustrates an example of AI/ML model-based neighboring-cell measurement.

The UE starts neighboring cell measurement based on the configuration received from the base station. At this time, the UE supporting the AI/ML model performs measurement only on the cell(s) indicated by the base station as Cell_SetB, and uses the measurement result of the measured cell(s) as the inputs to the model to predict the signal strengths (e.g., signal strength/quality) of the cell(s) indicated as Cell_SetA. Here, Cell_SetB may be a subset of Cell_SetA, or may consist of the same or different cells.

The base station transmits, to the UE, an indicator for indicating, in a measurement configuration including information related to neighboring cell measurement on neighboring cells, the cells to be used as inputs to the AI/ML model by the UE (i.e., the cells to be measured by the UE, Cell_SetB) and the cells to be derived as outputs (i.e., the cells to be predicted by the UE, Cell_SetA). Here, the indicator may additionally define, in addition to the cell list defined within the measurement object, a predicted cell list associated with the cell list. Alternatively, by defining a new measurement object for AI/ML (e.g., MeasObjectAIML), the cells to be measured (Cell_SetB list) and the cells to be predicted (Cell_SetA list) may be explicitly indicated, so that the UE may distinguish them. Here, Cell_SetB may be a subset of Cell_SetA. When Cell_SetB is a subset of Cell_SetA, this means that Cell_SetA includes the cell quality for Cell_SetB actually derived through measurement.

The UE obtains a cell list to be measured and performs serving/neighboring cell measurements based the cell list. However, when, in addition to the cell list defined within the measurement object, a predicted cell list associated with the cell list is additionally obtained, the cell quality results for the cells belonging to the cell list are used as inputs to the AI/ML model, and the results for the cells indicated by the predicted cell list are predicted as the outputs of the model. Accordingly, whether to transmit a reporting message is determined based on the predicted neighboring cell quality results derived by the AI/ML model.

On the other hand, when, through the definition of a new measurement object for AI/ML (e.g., MeasObjectAIML), the cell list to be measured (Cell_SetB list) and the cell list to be predicted (Cell_SetA list) are explicitly indicated, measurement is performed on the cells belonging to the explicitly indicated Cell_SetB list, and this is used as the inputs to the AI/ML model, while the results for the cells indicated by the Cell_SetA list are predicted as the outputs of the model. In this case as well, whether to transmit a reporting message is determined based on the predicted neighboring cell quality results derived by the AI/ML model.

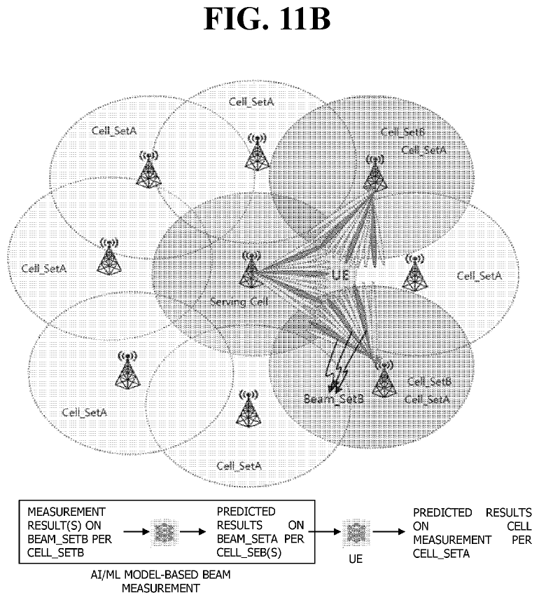

FIGS. 11A and 11B illustrate further examples of cell measurement.

In the matters described above in connection with FIGS. 10A and 10B, the UE may additionally receive beam configuration information for the cells belonging to Cell_SetB. The UE performs beam measurement based on SSB/CSI-RS using the received beam configuration information. Here, the UE may be instructed to apply the AI/ML model once more to derive the results for the beams belonging to Cell_SetB. This means that the UE obtains the beam strength/quality results of the beams associated with the cells (Cell_SetB) instructed to be actually measured by the UE, by using the AI/ML model. FIGS. 11A and 11B illustrate examples of cell measurement performed using the beam measurement result values for the cells belonging to Cell_SetB; in particular, FIG. 11B illustrates an example of cell measurement performed through AI/ML model-based beam measurement.

Referring to FIG. 11A, by measuring all of the beams (SSB/CSI-RS) configured for some of the neighboring cells, the cell quality may be derived using the measured beam results, and the cell quality for the cells belonging to Cell_SetA may be predicted based on the derived cell quality of the cells belonging to Cell_SetB. As another example, as illustrated in FIG. 11B, the cell quality of the cells belonging to Cell_SetB may be derived using beam prediction. This has the effect of reducing the overall beam measurement burden and the DL (downlink) RS (reference signal) overhead by deriving the results of the beams configured for the cells configured as Cell_SetB using the AI/ML model. To this end, the base station may transmit information on SetA/B (Beam_SetA/Beam_SetB) of the beams (SSB/CSI-RS) belonging to Cell_SetB in the measurement configuration. The measurement results for the beams belonging to Cell_SetB indicated in this manner enable predicting Beam_SetA for Cell_SetB, and the cell quality for Cell_SetB is derived using the predicted beam results belonging to Beam_SetA by the ‘AI/ML for BM’ model. The derived cell quality of Cell_SetB is then used as the input of the ‘AI/ML for mobility’ model to predict the cell quality for the entire Cell_SetA.

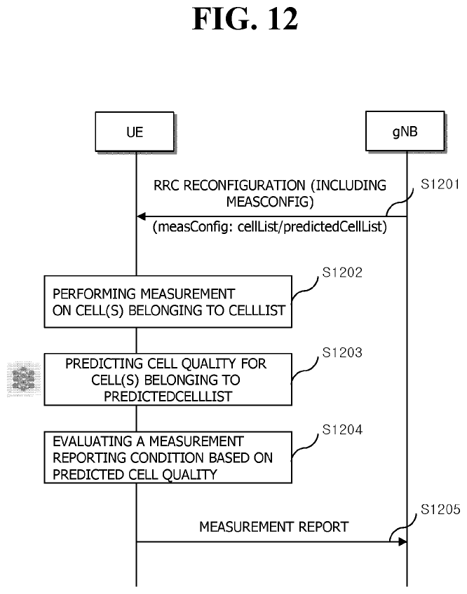

FIG. 12 illustrates a procedure of a UE and a base station according to an embodiment of the present disclosure.

Hereinafter, the operation of the UE will be described in detail with reference to FIG. 12.

The UE receives, from the base station, an RRC message including a measurement configuration (measConfig) (S1201). The corresponding message may be an RRC reconfiguration message and may include at least one of the following pieces of information.
Cell list (cellList)
Predicted cell list (predictedCellList) associated with the cell list

Here, the cell list is used for the input of the AI/ML model, and the predicted cell list is used for the output of the AI/ML model. The predicted cell list may include the cell list, or the predicted cell list may include the same or a smaller number of cell information items than the cell list.

Based on the information received from the base station, the UE performs measurements on the cells belonging to the cell list (S1202). Specifically, the UE measures the beam strengths for the cells belonging to the cell list and derives the cell quality from the measured beam strengths.

The UE uses the cell quality derived for the cell list as the input of the relevant AI/ML model and uses the received predicted cell list as the output of the AI/ML model. Through this, the UE performs prediction for the cells belonging to the predicted cell list (S1203). That is, the UE derives, using the AI/ML model, the predicted cell quality for the cells belonging to the predicted cell list.

Thereafter, the UE evaluates the reporting criteria using the predicted cell quality derived for the cells belonging to the predicted cell list (S1204). If a criterion (event) is satisfied, the UE transmits, to the base station, a measurement report message including the cell information configured by the base station (S1205).

Hereinafter, the operation of the base station will be described in detail with reference to FIG. 12.

The base station transmits, to the UE, an RRC message including a measurement configuration (measConfig) suitable for the AI/ML model/function of the UE (S1201). The corresponding message may be an RRC reconfiguration message and may include at least one of the following pieces of information.
Cell list (cellList)
Predicted cell list (predictedCellList) associated with the cell list

Here, the cell list is used for the input of the AI/ML model, and the predicted cell list is used for the output of the AI/ML model. The predicted cell list may include the cell list, or the predicted cell list may include the same or a smaller number of cell information items than the cell list.

Thereafter, the base station receives, from the UE, a measurement report message including the measurement result values for the cells belonging to the predicted cell list (S1205).

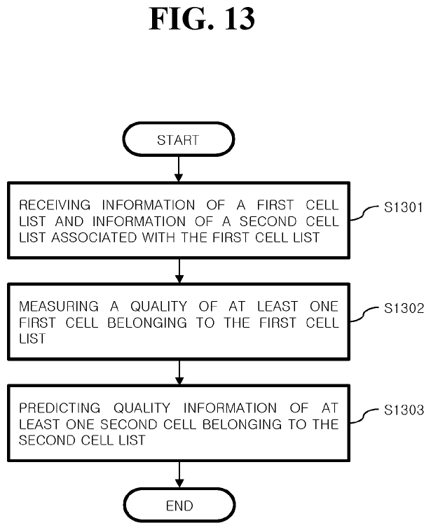

FIG. 13 is a flowchart illustrating a method of operating a UE according to another embodiment of the present disclosure.

Referring to FIG. 13, the UE receives, from the base station, information of a first cell list and information of a second cell list associated with the first cell list (S1301) and measures a quality of at least one first cell belonging to the first cell list (S1302). Further, the UE predicts quality information of at least one second cell belonging to the second cell list (S1303). Here, the quality information of the at least one second cell is predicted using an AI (artificial intelligence)/ML (machine learning) model based on the measured quality of the at least one first cell.

The UE may evaluate a measurement reporting condition based on the predicted quality information of the at least one second cell, and may transmit a measurement report to the base station based on satisfaction of the evaluated measurement reporting condition.

Meanwhile, the first cell list may be associated with input of the AI/ML model, and the second cell list may be associated with output of the AI/ML model. Further, the second cell list may include the first cell list.

Furthermore, the information of the first cell list and the information of the second list may be received from the base station through an RRC (radio resource control) message including a measurement configuration.

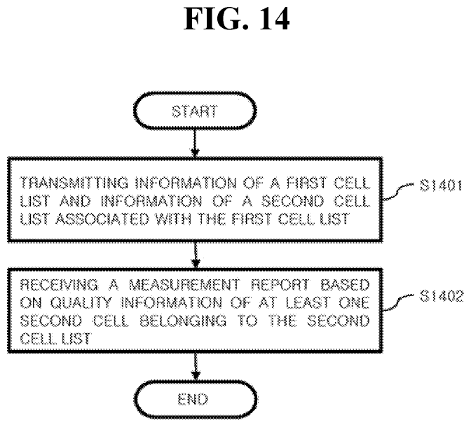

FIG. 14 is a flowchart illustrating a method of operating a base station according to an embodiment of the present disclosure.

Referring to FIG. 14, the base station transmits, to the UE, information of a first cell list and information of a second cell list associated with the first cell list (S1401). Thereafter, the base station receives, from the UE, a measurement report based on quality information of at least one second cell belonging to the second cell list (S1402). Here, the quality information of the at least one second cell is predicted using an AI (artificial intelligence)/ML (machine learning) model based on the measured quality of at least one first cell.

Meanwhile, the first cell list may be associated with input of the AI/ML model, and the second cell list may be associated with output of the AI/ML model. Further, the second cell list may include the first cell list.

Furthermore, the information of the first cell list and the information of the second list may be transmitted from the base station to the UE through an RRC (radio resource control) message including a measurement configuration.

The contents disclosed in the present disclosure may each be applied independently or may be operated in any combined form. Furthermore, although the present disclosure is described based on a 5G NR system, the concept of the present disclosure, regardless of the specific wireless communication technology, may fall within the scope of the present disclosure in any cases applying the concept of the present disclosure.

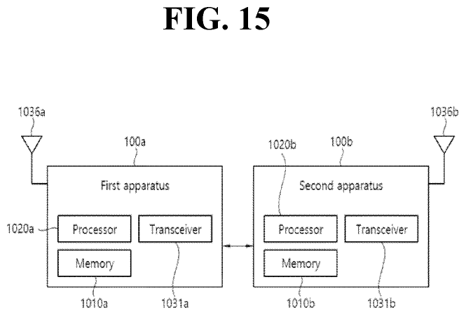

FIG. 15 illustrates an apparatus according to an embodiment of the present disclosure.

Referring to FIG. 15, the wireless communication system may include a first apparatus 100a and a second apparatus 100b.

The first apparatus 100a may be a base station, a network node, a transmitting UE, a receiving UE, a wireless device, a wireless communication apparatus, a vehicle, a vehicle equipped with an autonomous driving function, a Connected Car, a drone (Unmanned Aerial Vehicle, UAV), an AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a fintech device (or a financial device), a security device, a climate/environment device, a device related to a 5G service, or a device related to other fields of the fourth industrial revolution.

The second apparatus 100b may be a base station, a network node, a transmitting UE, a receiving UE, a wireless device, a wireless communication apparatus, a vehicle, a vehicle equipped with an autonomous driving function, a Connected Car, a drone (Unmanned Aerial Vehicle, UAV), an AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a fintech device (or a financial device), a security device, a climate/environment device, a device related to a 5G service, or a device related to other fields of the fourth industrial revolution.

The first apparatus 100a may include at least one or more processors such as a processor 1020a, at least one or more memories such as a memory 1010a, and at least one or more transceivers such as a transceiver 1031a. The processor 1020a may perform the functions, procedures, and/or methods described above. The processor 1020a may perform one or more protocols. For example, the processor 1020a may perform one or more layers of a radio interface protocol. The memory 1010a is connected to the processor 1020a and may store various forms of information and/or instructions. The transceiver 1031a is connected to the processor 1020a and may be controlled to transmit and receive wireless signals.

The second apparatus 100b may include at least one processor such as a processor 1020b, at least one or more memory devices such as a memory 1010b, and at least one transceiver such as a transceiver 1031b. The processor 1020b may perform the functions, procedures, and/or methods described above. The processor 1020b may implement one or more protocols. For example, the processor 1020b may implement one or more layers of a radio interface protocol. The memory 1010b is connected to the processor 1020b and may store various forms of information and/or instructions. The transceiver 1031b is connected to the processor 1020b and may be controlled to transmit and receive wireless signals.

The memory 1010a and/or the memory 1010b may be connected (e.g., located) respectively inside or outside the processor 1020a and/or the processor 1020b and may be connected to other processors using various technologies such as wired or wireless connections.

The first apparatus 100a and/or the second apparatus 100b may have one or more antennas. For example, the antenna 1036a and/or the antenna 1036b may be configured to transmit and receive wireless signals.

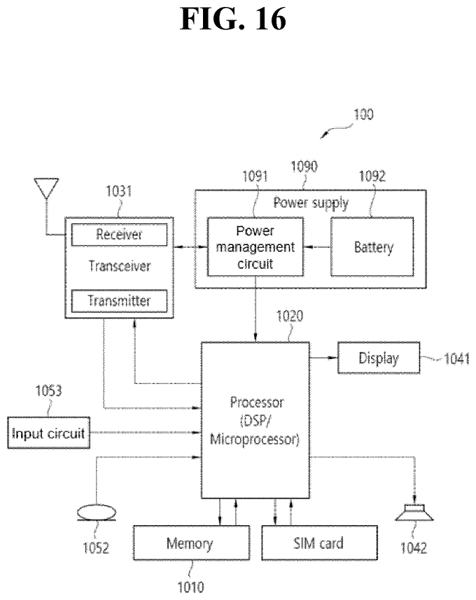

FIG. 16 is a block diagram illustrating a configuration of a UE according to an embodiment of the present disclosure.

In particular, FIG. 16 is a diagram illustrating the apparatus of FIG. 15 in more detail.

The apparatus includes a memory 1010, a processor 1020, a transceiver 1031, a power management module 1091, a battery 1092, a display 1041, an input unit 1053, a speaker 1042 and a microphone 1052, a SIM (subscriber identification module) card, and one or more antennas.

The processor 1020 may be configured to implement the proposed functions, procedures, and/or methods described in the present disclosure. The layers of the radio interface protocol may be implemented in the processor 1020. The processor 1020 may include an ASIC (application-specific integrated circuit), other chipsets, a logic circuit, and/or a data processing device. The processor 1020 may be an AP (application processor). The processor 1020 may include at least one of a DSP (digital signal processor), a CPU (central processing unit), a GPU (graphics processing unit), and a Modem (modulator and demodulator). Examples of the processor 1020 may be a SNAPDRAGON™ series processor manufactured by Qualcomm®, an EXYNOS™ series processor manufactured by Samsung®, an A-series processor manufactured by Apple®, a HELIO™ series processor manufactured by MediaTek®, an ATOM™ series processor manufactured by INTEL®, a KIRIN™ series processor manufactured by HiSilicon®, or a corresponding next-generation processor.

The power management module 1091 manages power for the processor 1020 and/or the transceiver 1031. The battery 1092 supplies power to the power management module 1091. The display 1041 outputs the results processed by the processor 1020. The input unit 1053 receives input to be used by the processor 1020. The input unit 1053 may be displayed on the display 1041. The SIM card is an integrated circuit used to securely store the IMSI (international mobile subscriber identity) and related keys, used to identify and authenticate subscribers in mobile telephone devices such as mobile phones and computers. Many SIM cards may also store contact information.

The memory 1010 is operatively coupled to the processor 1020 and stores various information for operating the processor 610. The memory 1010 may include a ROM (read-only memory), a RAM (random access memory), a flash memory, a memory card, a storage medium, and/or other storage devices. When the embodiment is implemented in software, the techniques described in the present disclosure may be implemented as modules (e.g., procedures, functions, etc.) performing the functions described in the present disclosure. The modules may be stored in the memory 1010 and executed by the processor 1020. The memory 1010 may be implemented inside the processor 1020. Alternatively, the memory 1010 may be implemented outside the processor 1020 and may be communicatively connected to the processor 1020 through various means known in the art.

The transceiver 1031 is operatively coupled to the processor 1020 and transmits and/or receives wireless signals. The transceiver 1031 includes a transmitter and a receiver. The transceiver 1031 may include a baseband circuit for processing radio frequency signals. The transceiver controls one or more antennas to transmit and/or receive wireless signals. The processor 1020 transmits command information to the transceiver 1031 to initiate communication, for example, to transmit a wireless signal constituting voice communication data. An antenna may be configured to transmit and receive wireless signals. When a wireless signal is received, the transceiver 1031 may forward the signal for processing by the processor 1020 and may convert the signal to baseband. The processed signal may be converted into audible or readable information output through the speaker 1042.

The speaker 1042 outputs audio-related results processed by the processor 1020. The microphone 1052 receives audio-related input to be used by the processor 1020.

The user inputs command information, for example, a phone number, by pressing (or touching) a button of the input unit 1053 or by voice activation using the microphone 1052. The processor 1020 receives such command information and processes it to perform appropriate functions, such as placing a call to the phone number. Operational data may be retrieved from the SIM card or the memory 1010. The processor 1020 may also display the command information or operational data on the display 1041 for the user to recognize and for convenience.

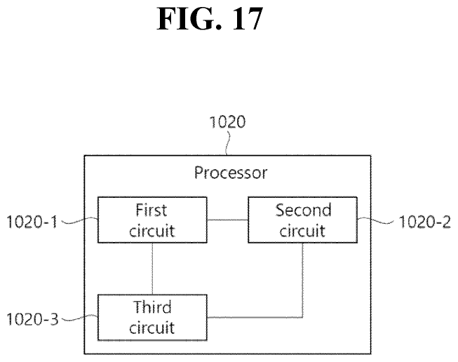

FIG. 17 is a block diagram illustrating a configuration of a processor implementing the disclosure of the present disclosure.

As can be seen from FIG. 17, the processor 1020 implementing the disclosure of the present disclosure may include a plurality of circuits in order to implement the proposed functions, procedures, and/or methods described in the present disclosure. For example, the processor 1020 may include a first circuit 1020-1, a second circuit 1020-2, and a third circuit 1020-3. Furthermore, although not shown, the processor 1020 may include more circuitry. Each circuit may include a plurality of transistors.

The processor 1020 may be referred to as an ASIC (application-specific integrated circuit) or an AP (application processor), and may include at least one of a DSP (digital signal processor), a CPU (central processing unit), and a GPU (graphics processing unit).

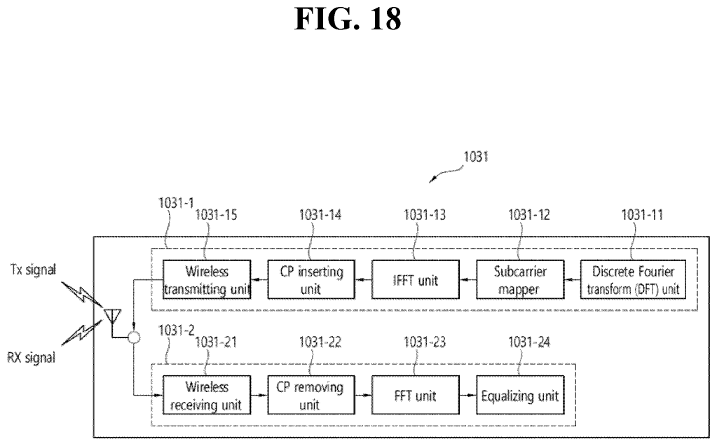

FIG. 18 is a block diagram illustrating in detail the transceiver of the first apparatus shown in FIG. 15 or the transceiver of the apparatus shown in FIG. 16.

Referring to FIG. 18, the transceiver 1031 includes a transmitter 1031-1 and a receiver 1031-2. The transmitter 1031-1 includes a DFT (Discrete Fourier Transform) unit 1031-11, a subcarrier mapper 1031-12, an IFFT unit 1031-13, a CP insertion unit 1031-14, and an RF transmission unit 1031-15. The transmitter 1031-1 may further include a modulator. The transmitter may further include, for example, a scramble unit (not shown), a modulation mapper (not shown), a layer mapper (not shown), and a layer permutator (not shown), arranged prior to the DFT unit 1031-11. That is, in order to prevent an increase in PAPR (peak-to-average power ratio), the transmitter 1031-1 first passes the information through the DFT 1031-11 before mapping the signal to the subcarriers. The signal spread (or, equivalently, precoded) by the DFT unit 1031-11 is subcarrier-mapped through the subcarrier mapper 1031-12, and is then passed through the IFFT (Inverse Fast Fourier Transform) unit 1031-13 to be converted into a time-domain signal.

The DFT unit 1031-11 performs DFT on the input symbols and outputs complex-valued symbols. For example, when Ntx symbols are input (where Ntx is a natural number), the DFT size is Ntx. The DFT unit 1031-11 may be referred to as a transform precoder. The subcarrier mapper 1031-12 maps the complex-valued symbols to respective subcarriers in the frequency domain. The complex-valued symbols may be mapped to resource elements corresponding to a resource block allocated for data transmission. The subcarrier mapper 1031-12 may be referred to as a resource element mapper. The IFFT unit 1031-13 performs IFFT on the input symbols and outputs a baseband signal for data, a time-domain signal. The CP insertion unit 1031-14 copies a part of the rear portion of the baseband signal for data and inserts it into the front portion of the baseband signal for data. CP insertion prevents ISI (Inter-Symbol Interference) and ICI (Inter-Carrier Interference), thereby maintaining orthogonality even in multipath channels.

On the other hand, the receiver 1031-2 includes a wireless reception unit 1031-21, a CP removal unit 1031-22, an FFT unit 1031-23, an equalizer 1031-24, and the like. The wireless reception unit 1031-21, the CP removal unit 1031-22, and the FFT unit 1031-23 of the receiver 1031-2 perform the inverse functions of the wireless transmission unit 1031-15, the CP insertion unit 1031-14, and the IFFT unit 1031-13 of the transmitter 1031-1. The receiver 1031-2 may further include a demodulator.

While preferred embodiments have been exemplarily described above, the disclosure of the present disclosure is not limited to such specific embodiments, and may be modified, changed, or improved in various forms within the scope of the present disclosure and the claims.

Although in the exemplary systems described above, the methods are described based on flowcharts as a series of steps or blocks, the order of the steps described is not limited, and certain steps may occur in a different order or simultaneously with other steps than those described above. Furthermore, those skilled in the art will understand that the steps shown in the flowcharts are not exclusive, that other steps may be included, or that one or more steps in the flowcharts may be deleted without affecting the scope of the disclosure.

The claims described in the present disclosure may be combined in various ways. For example, the technical features of the method claims of the present disclosure may be combined to be implemented as an apparatus, and the technical features of the apparatus claims of the present disclosure may be combined to be implemented as a method. Furthermore, the technical features of the method claims and the technical features of the apparatus claims of the present disclosure may be combined to be implemented as an apparatus, and the technical features of the method claims and the technical features of the apparatus claims of the present disclosure may be combined to be implemented as a method.

1-16. (canceled)

17. A method performed by a user equipment (UE) configured to perform neighboring cell measurement and reporting using an artificial intelligence/machine learning (AI/ML) model in a wireless communication system, the method comprising:
receiving, from a base station (BS), a radio resource control (RRC) message including second cell list information associated with the first cell list information;
performing, based on the received RRC message, a cell quality measurement on at least one cell belonging to a first cell list indicated by the first cell list information; and
predicting, using the AI/ML model, cell quality information of at least one cell belonging to a second cell list indicated by the second cell list information based on measured cell quality information for the at least one cell belonging to the first cell list.

18. The method of claim 17, wherein the first cell list information indicates one or more cells to be measured by the UE, and the second cell list information indicates one or more cells for which cell quality information is to be predicted by the UE.

19. The method of claim 17, wherein the second cell list information includes association information indicating an association between a measured cell corresponding to the first cell list and a predicted cell corresponding to the second cell list.

20. The method of claim 19, wherein the association information is configured for at least one of training or inference of the AI/ML model.

21. The method of claim 17, wherein the first cell list is associated with input to the AI/ML model, and the second cell list is associated with output from the AI/ML model.

22. The method of claim 17, wherein the second cell list includes the first cell list.

23. The method of claim 17, wherein the second cell list includes a number of cells less than or equal to a number of cells included in the first cell list.

24. The method of claim 17, wherein at least one cell belonging to the first cell list and at least one cell belonging to the second cell list are associated with different frequencies.

25. The method of claim 17, further comprising:
transmitting, to the BS, a measurement report based on satisfaction of the reporting condition.

26. A method performed by a base station (BS) in a wireless communication system, the method comprising:
transmitting, to a user equipment (UE) supporting an artificial intelligence/machine learning (AI/ML) model, a radio resource control (RRC) message including second cell list information associated with first cell list information; and
receiving, from the UE, a measurement report based on predicted cell quality of a cell belonging to a second cell list indicated by the second cell list information,
wherein the predicted cell quality is predicted using the AI/ML model based on measured cell quality information for a cell belonging to a first cell list indicated by the first cell list information.

27. The method of claim 26, wherein the first cell list information indicates one or more cells to be measured by the UE, and the second cell list information indicates one or more cells for which cell quality information is to be predicted by the UE.

28. The method of claim 26, wherein the second cell list information includes association information indicating an association between a measured cell corresponding to the first cell list and a predicted cell corresponding to the second cell list.

29. The method of claim 28, wherein the association information is configured for at least one of training or inference of the AI/ML model.

30. The method of claim 26, wherein at least one cell belonging to the first cell list and at least one cell belonging to the second cell list are associated with different frequencies.

31. The method of claim 26, wherein the measurement report is received based on satisfaction of a reporting condition evaluated by the UE using the predicted cell quality.

32. A user equipment (UE) configured to perform neighboring cell measurement and reporting using an artificial intelligence/machine learning (AI/ML) model in a wireless communication system, the UE comprising:
at least one processor; and
at least one memory storing instructions and operably connected to the at least one processor,
wherein, based on the instructions being executed by the at least one processor, the UE is configured to:
receive, from a base station (BS), a radio resource control (RRC) message including second cell list information associated with first cell list information;
perform, based on the received RRC message, a cell quality measurement on a cell belonging to a first cell list indicated by the first cell list information; and
predict, using the AI/ML model, cell quality information of a cell belonging to a second cell list indicated by the second cell list information based on measured cell quality information for the cell belonging to the first cell list.

33. The UE of claim 32, wherein the first cell list information indicates one or more cells to be measured by the UE, and the second cell list information indicates one or more cells for which cell quality information is to be predicted by the UE.

34. The UE of claim 32, wherein the second cell list information includes association information indicating an association between a measured cell corresponding to the first cell list and a predicted cell corresponding to the second cell list.

35. The UE of claim 32, wherein the first cell list is associated with input to the AI/ML model, and the second cell list is associated with output from the AI/ML model.

36. The UE of claim 32, wherein at least one cell belonging to the first cell list and at least one cell belonging to the second cell list are associated with different frequencies.
